(19) United States
(12) Patent Application Publication
(10) Pub. No.: US 2010/0172824 A1
(43) Pub. Date: Jul. 8, 2010

(54) Method for Preparing Agglomerated Metal Oxides

(75) Inventor: Stephen P. Kinniard, Ellicott City, MD (US)

Correspondence Address: DUNLAP CODDING, P.C. - MILLENNIUM, P.O. BOX 16370, OKLAHOMA CITY, OK, 73113, US

(73) Assignee: Millennium Inorganic Chemicals, Inc.

(21) Appl. No.: 12/725,798

(22) Filed: Mar. 17, 2010

Related U.S. Application Data
(63) Continuation-in-part of application No. 12/342,902, filed on Dec. 23, 2008, now abandoned.

(51) Int. Cl. C01G 23/047

(52) U.S. Cl. 423/610

(57) ABSTRACT

A method for preparing agglomerates of a metal oxide by mixing metal oxide particles with a non-aqueous liquid to form a slurry, and then drying the slurry.

### CROSS REFERENCE TO RELATED APPLICATIONS

This application is a continuation-in-part of U.S. Ser. No. 12/342,902, filed Dec. 23, 2008, the contents of which are expressly incorporated herein in its entirety by reference.

### BACKGROUND OF THE INVENTION

The present invention relates generally to a method for agglomerating metal oxide particles, and, more particularly, to a method for preparing agglomerates of metal oxide pigment particles.

Metal oxide particles, such as pigment particles, are often used in cosmetics, detergents, paint, plastics, and other industries to add color to a product and/or to opacify the product. In order to opacify the product, the metal oxide particles need to be a fine powder of sub-micron size. Such fine powders are cohesive and tend to have poor flow characteristics. Better flow characteristics are desired for precise control of particle flow patterns in any continuous process, such as, for example, in plastic compounding.

Usual methods to enhance the flow of fine powders involve agglomerating the metal oxide particles into larger sizes. Methods employed for agglomerating metal oxide particles can use binders, which provide adhesive force to the agglomerates and also increase stability of the agglomerated particles. However, binders typically remain with the agglomerates and can constitute a contaminant for the end user of the product. Typical binders are selected from water, waxes, and/or oils. Waxes and oils may have deleterious effects while water may not be desirable for use in high temperature environments found in plastic compounding.

Another problem with known methods for agglomerating metal oxide particles is that they can produce robust agglomerated metal oxide particles with a higher than desirable level of cohesion. Normal shear, which is typically applied in plastic compounding, is not sufficient to break up such robust agglomerated particles, and the particles exhibit poor dispersability.

There is a need for improved methods for preparing agglomerated metal oxide particles that overcome the above problems, while maintaining good dispersability characteristics.

### SUMMARY OF THE INVENTION

The present invention is an improved method for preparing agglomerates of metal oxide particles which comprises admixing metal oxide particles with a non-aqueous liquid to form a slurry, and then drying the slurry to form the agglomerates. The present invention is particularly well-suited for preparing agglomerates of titanium dioxide particles.

### DETAILED DESCRIPTION OF THE INVENTION

The present invention, according to one embodiment, comprises mixing metal oxide particles with a 100% non-aqueous liquid to form a slurry and then drying the slurry whereby agglomerates are formed. The metal oxide particles typically have an average primary particle diameter of less than 5 microns, but pigments will typically have an average primary particle diameter of less than 1 micron. Although for non-pigmentary applications (e.g., so-called nano-materials, such as UV blockers and catalysts), the average primary particle diameter can be less than 100 nanometers. Agglomerates of metal oxide particles produced according to the invention exhibit dispersability substantially equivalent to the dispersability of the metal oxide particles before agglomeration. This means that the powder is capable of being uniformly distributed in the end polymer or coating without an excessive amount of agglomerates remaining non-dispersed.

The method of the invention is particularly applicable to metal oxide particles that are hydrophobic or hydrophilic pigments where their primary function is to opacify an object into which they may be incorporated. Examples of metal oxides which are pigments include, but are not limited to, titanium dioxide and iron oxide. Pigments such as titanium dioxide may be coated with an organic compound or a mixture of two or more organic compounds to enhance their compatibility with a host material. Examples of organic compounds used to enhance pigment compatibility include organosilanes and organophosphorous compounds. The mean size of pigment particles is in the range of 0.1-0.5 microns.

The term “non-aqueous liquid” is used herein to mean a 100% non-aqueous liquid that has the capability to both wet a hydrophobic powder and exhibit a substantially lower surface tension than water such that the drying process does not produce mechanically strong agglomerates. A further property for such a non-aqueous liquid is a low boiling point to permit ease of drying. Aqueous slurries generally do not meet these criteria. A non-aqueous liquid most preferred for carrying out the process of the invention is an alkane, such as hexane. However, suitable non-aqueous liquids can be selected from aliphatic compounds, aromatic compounds and mixtures thereof, such as, for example, from among alkanes, alkenes, alkynes, esters, ethers, ketones, aldehydes, alcohols, halides, amines, and amides. Hexane, heptane, and acetone are non-aqueous liquids useful in carrying out the method of the invention. Preferably, the non-aqueous liquid will have a boiling point in the range of from 50° C. to 80° C. for ease of drying.

Admixing the metal oxide with the non-aqueous liquid can be conveniently accomplished in a high speed disperser, such as a Cowles disperser, or mixing can be accomplished in a continuous manner by a compounding operation, such as with a twin screw extruder in which the metal oxide and non-aqueous liquid are mixed to form a thick slurry, or paste, and the paste is extruded into a preform, e.g., discrete pellets. The ratio of liquid to solid is controlled to ensure a desired consistency for the slurry, which can range from a thin slurry to a thick paste. The amount of liquid necessary may also be influenced by factors such as porosity and size of the metal oxide particles, but is typically in the range of from 30% to 70% of the total weight of the resulting slurry. Extruded metal oxide preforms will have an average diameter in the range of 2-3 mm, but the diameter can range up to 10 mm or even greater. There is no limit to the size of the preform except that which is practical for the end application. The preforms are then dried, and the dry agglomerates are recovered.

Drying can be accomplished by natural evaporation of the non-aqueous liquid under ambient conditions, or drying can be accomplished by evaporating the non-aqueous liquid by forced-air drying, which will accelerate the drying process. The preforms may also be dried by heating, such as by convection, conduction or radiant heating. Examples include contacting the preforms with a hot inert gas, such as nitrogen, or by heating the preforms on a hot surface, such as, for example, a heated metal sheet of the type used in a tunnel dryer. The preforms may be subjected to forced drying by application of vacuum, with or without additional heat, or they may be immersed under another liquid that has a temperature greater than the boiling point of the non-aqueous liquid, such as hot water. By way of example, the preforms of the metal oxide formed using hexane as the non-aqueous liquid can be immersed in water that has been heated to a temperature of at least 75° C. Hexane, having a boiling point of 65° C., is flashed off, and the agglomerated product is recovered from the water and dried further. Drying equipment useful in carrying out the method of the invention may include spray dryers, tunnel-type dryers, and rotary kilns. Preferably, the evaporated non-aqueous liquid is recovered by condensation and re-used to prepare fresh slurry or paste. Although agglomerates produced according to the invention are substantially dried, some residual amount of non-aqueous liquid may remain, typically less than 5% by weight. Residual content is preferably less than 1% by weight for readily volatile compounds such as alkanes (e.g., hexane) and ketones (e.g., acetone). The agglomerates may be broken down further after drying to reach a desired size which provides acceptable flow properties for the intended end use application. Acceptable flow properties for the agglomerates include “free flowing”, whereby flow is steady and continuous.

Additives may be added to the slurry formed in step one according to the method of the invention to aid processing of the agglomerates. Suitable additives include polyols, organic silicon compounds, organo-phosphorous compounds, fatty acids, waxes, metal stearates, cellulosics, fatty acids, fatty esters, wax esters, glycerol esters, glycol esters, fatty alcohol esters, fatty alcohols, fatty amides, olefin polymers, polyolefin waxes, and mixtures thereof.

Metal oxide agglomerates are employed to provide whiteness and opacity to a variety of consumer products, such as paints, coatings, plastics, papers, inks, foods, medicines in the form of pills and tablets, as well as most toothpastes. In cosmetic and skin care products, the metal oxide may be used for both pigmentation and thickening. Metal oxides may also be used in tattoo pigments and styptic pencils and in ceramic glazes where the metal oxide acts as opacifier and seeds crystal formation. Metal oxide agglomerates are further used in plastic compounding to make plastic objects. In addition to exhibiting improved flow characteristics, metal oxide agglomerates produced according to the invention also contribute to better hygienic conditions as they are less dusty.

### Test Method for Measuring Pigment Dispersion

Dispersions of non-agglomerated and agglomerated metal oxides were measured and compared, and the dispersions of agglomerates were prepared by different methods, including tumbling, compaction as well as agglomeration by drying from a substantially non-aqueous liquid according to the invention. The method used to measure dispersion was as follows:

Dispersion of metal oxide into organic polymer is measured by recording the relative amount of particulate metal oxide trapped onto screens of extruder screen packs using a small-scale laboratory extrusion apparatus.

A mixture of 75% by weight metal oxide concentrate and low density polyethylene was prepared by mixing 337.7 grams of micronized TiO₂ and 112.6 grams of NA209 LDPE (manufactured by Equistar) using a Haake 3000 Rheomix mixer. The mixer was controlled and monitored using a Haake 9000 Rheocord Torque Rheometer. The mixture was first dry blended and then added at 75° C. to the mixer having rotors operating at 50 rpm. The mixer temperature was programmed to increase to 120° C. one minute after the dry blended mixture was added. When the mixing operation reached steady state, typically taking about 3 to 4 minutes, the mixture was mixed for an additional 3 minutes. The mixture was removed from the mixer and granulated using a Cumberland crusher.

Dispersion was measured using a Killion model KL-100 single screw extruder equipped with a 20:1 length to diameter screw preheated to 330°, 350°, 390° and 380° F. from zone 1 to die, respectively, and operated at 70 rpm. A purge of 1000 grams of NA952 LDPE manufactured by Equistar was run through the system, and a new screen pack was installed. The screen pack consisted of 40/500/200/100 mesh screens from the die towards the extruder throat. After temperature stabilization, 133.33 grams of granulated 75% TiO₂ concentrate was fed into the extruder. This was followed with 1500 grams of NA952 purge as the feed hopper was emptied. After the LDPE purge was extruded, the screens were removed, separated and tested using a relative count technique from measurements from an X-ray fluorescence spectrometer. The number of TiO₂ counts per second was obtained for the 100, 200 and 500 mesh screens in the pack and totaled to obtain the dispersion result. Lower TiO₂ counts per second are desired. A count result of less than 5000 is considered to represent good dispersion, below 1000 is excellent.

### Dispersion Standard

Tiona® 188, a finely divided commercial titanium dioxide manufactured by Millennium Inorganic Chemicals was used as a dispersion standard. Tiona® 188 had a hydrophobic organo-silicon surface treatment and has exhibited excellent dispersion performance in plastics compounding applications. Tiona® 188 was run in the above test method four (4) times to establish test reproducibility. The results are shown below:
Average Dispersion 609 counts
Standard Deviation 217 counts.

The following examples illustrate values of dispersability before and after agglomeration of titanium dioxide, and they also provide an indication of the values of dispersability for agglomerates of titanium dioxide agglomerated by different methods.

### EXAMPLE 1

### Tumbling

400 grams of Tiona® 188, the same material as the dispersion standard, was rolled in a 1 quart plastic jar at 50 rpm for 1.5 hours or for 18 hours.

After tumbling, the pigment started to agglomerate into spheres as large as a few mm, however the agglomerates exhibited a range of sizes from fine powder to spheres of a few mm. The product which had tumbled for the longer period was observed to be more uniform in size. The resulting products were tested for dispersion according to the procedure described above, and the results are shown below in Table 1:

TABLE 1

| Sample | Dispersion (XRF counts) |
|---|---|
| Tumbled 1.5 hours | 1127 |
| Tumbled 18 hours | 4107 |

It can be seen that tumbling has resulted in a deterioration in dispersion values. Longer tumbling times, although better for powder flow and agglomeration, are more detrimental to dispersion.

### EXAMPLE 2

### Compaction

50 pounds of the same pigment (Tiona® 188), as used in Example 1 was passed through pressure rolls in a Fitzpatrick Company L-83 Compactor. Cylinders roll under pressure and the Tiona® 188 powder was passed between the rolls and compacted by the pressure exerted. The rolls operated at 5 rpm and had a booster pressure of 400 psi. The product was formed into small flakes had a range of agglomerate sizes collected in a number of sieves. Each sieve fraction was tested for dispersion, and the results are shown below in Table 2:

TABLE 2

| Sample | Dispersion |
|---|---|
| 14 mesh fraction | 5148 |
| 20 mesh fraction | 4344 |
| 30 mesh fraction | 2769 |
| 35 mesh fraction | 3140 |
| 40 mesh fraction | 3912 |
| 50 mesh fraction | 4281 |
| 70 mesh fraction | 6577 |
| Pan (remaining fine powder) | 4213 |

It can be seen that passing the pigment through pressure rolls to compact it has caused a substantial degradation to the pigment's dispersability, irrespective of the sieve fraction tested.

### EXAMPLE 3

### Drying from a Non-Aqueous Liquid

171 grams of Tiona® 188, as used in Example 1, was mixed with (a) 231 grams of heptane or (b) 294 grams of acetone in a 1-quart container using a Cowles disperser at 3000 rpm. The resulting mixture was allowed to sit overnight, and the non-aqueous liquid (heptane or acetone) readily evaporated. The resulting dry mass which had formed was roughly broken up by passing through a 4 mm sieve with minimal force. The resultant product, which contained significant amounts of large agglomerates, was tested for dispersion. The results are shown below in Table 3:

TABLE 3

| Sample | Dispersion |
|---|---|
| Tiona ® 188 dried in acetone | 436 |
| Tiona ® 188 dried in heptane | 485 |

It can be seen that drying the Tiona® 188 from a non-aqueous liquid, even when large agglomerates have formed, breaks down to give dispersion values equivalent to the non-agglomerated Tiona® 188 powder. Both results are within 1 standard deviation of the non-agglomerated Tiona® 188 powder used in the Examples as the dispersion standard.

### EXAMPLE 4

### Drying From a Non-Aqueous Liquid

The same Tiona® 188, as used in the preceding examples, was slurried up in (a) hexane or (b) acetone at 50% solids and then dried in a spray dryer using heated nitrogen as the drying means. The product was collected and tested for dispersion, and the results are shown below in Table 4:

TABLE 4

| Sample | Dispersion |
|---|---|
| Tiona ® 188 spray dried in acetone | 719 |
| Tiona ® 188 spray dried in hexane | 749 |

The product dried from the non-aqueous liquid (acetone/hexane) using a spray dryer exhibits dispersion values that are within 1 standard deviation of the non-agglomerated® Tiona 188, and can be held as statistically equivalent.

### EXAMPLE 5

### Drying from a Non-Aqueous Liquid

Tiona® 188, as used in the previous examples, was prepared into a paste containing 73% solids in hexane, and extruded through a caulking gun to a range of extrudate diameters varying from ⅛″ to ½″. The resulting product was allowed to air dry in a fume hood, collected and tested for dispersion. The results are shown below in Table 5:

TABLE 5

| Sample | Dispersion |
|---|---|
| ⅛″ Extrudate | 652 |
| ¼″ Extrudate | 536 |
| ½″ Extrudate | 455 |

The product dried from the non-aqueous liquid exhibits dispersion values that are statistically indistinguishable from the non-agglomerated finely divided pigment. Even though pigment mixture was agglomerated to as large as a half inch in diameter, no deterioration in dispersability is observed.

The examples above demonstrate that forming a paste or slurry from a finely divided pigment in a non-aqueous liquid, followed by drying to form agglomerates according to the invention, results in an agglomerated product which suffers no deterioration in dispersion when compared to the prior art agglomeration methods of tumbling and compaction.

The foregoing descriptions of embodiments of the invention have been presented for purposes of illustration and are not intended to be exhaustive or to limit the invention to the precise forms disclosed. Various equivalents are contemplated as circumstance may suggest or render expedient.

What is claimed is:

1. A method for preparing agglomerates of a metal oxide comprising:
admixing metal oxide particles with a non-aqueous liquid to form a slurry; and drying the slurry.

2. The method of claim 1 further comprising extruding the slurry to form metal oxide preforms.

3. The method of claim 1, wherein the metal oxide comprises a pigment.

4. The method of claim 1, wherein the metal oxide comprises titanium dioxide.

5. The method of claim 1, wherein the metal oxide comprises particles having an average primary particle diameter of less than 100 nanometers.

6. The method of claim 5, wherein the non-aqueous liquid is selected from the group consisting of aliphatic compounds, aromatic compounds and mixtures thereof.

7. The method of claim 6, wherein the non-aqueous liquid is selected from alkanes, alkenes, alkynes, esters, ethers, ketones, aldehydes, alcohols, halides, amines, and amides.

8. A method for improving the dispersability of an agglomerated titanium dioxide pigment comprising:
(i) admixing the titanium dioxide pigment with a non-aqueous liquid to form a slurry; and
(ii) drying the slurry.

9. The method of claim 8, wherein the non-aqueous liquid is selected from the group consisting of alkanes, alkenes, alkynes, esters, ethers, ketones, aldehydes, alcohols, halides, amines, amides and mixtures thereof.

10. The method of claim 9 wherein the non-aqueous liquid is hexane.
